(19) United States
(12) Patent Application Publication
(10) Pub. No.: US 2004/0165521 A1
(43) Pub. Date: Aug. 26, 2004

(54) Optical pickup device, signal processing method for optical pickup device, and optical disk drive unit

(76) Inventors: Hiroshi Kayama, Takatsuki-shi (JP); Kazuo Momoo, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/781,617

(22) Filed: Feb. 20, 2004

(30) Foreign Application Priority Data
Feb. 21, 2003 (JP) 2003-044528(PAT.)
Jan. 8, 2004 (JP) 2004-003152(PAT.)

(51) Int. Cl. G11B 7/00

(52) U.S. Cl. 369/124.12

(57) ABSTRACT

An optical pickup device, a signal processing method for the optical pickup device, and an optical disk drive unit are provided which are capable of eliminating or lessening the influence on the RF signal by a variation in the emission power of a laser, without changing the structure of the laser or varying reproduction power. A signal processing circuit 19 of an optical pickup device 2, which converges light emitted from a laser 11 upon an optical disk through an objective lens and executes recording and reproduction of information on the optical disk, comprises: a photo-detector 18 which receives reflected light from the optical disk; a former-light detector 17 which receives a part of emitted light from the laser 11; a division circuit 22 which divides an RF signal outputted from the photo-detector 18 by a former-light signal outputted from the former-light detector 17; and an RF detection circuit 23 which detects an RF signal from the signal obtained by a division of the division circuit 22.

### BACKGROUND OF THE INVENTION

1. Field of the Invention

The present invention relates to an optical pickup device which executes at least one of recording and reproduction of information on an optical disk, a signal processing method for the optical pickup device, and an optical disk drive unit.

2. Description of the Related Art

In a conventional optical pickup device, light emitted from a laser passes through a collimator lens, and a part of the light is reflected by a PBS (or polarizing beam splitter), incident upon a former-light detector and received by the former-light detector. The former-light detector converts the received light into an electric signal. The electric signal converted by the former-light detector is used for power control of the laser. Most of the emitted light passes through the PBS and is incident upon a ¼ wave plate. The light that has passed through the PBS is converted, with respect to its polarization direction, from linearly polarized light to circularly polarized light by the ¼ wave plate. The light whose polarization direction is converted by the ¼ wave plate is converged upon the disk surface of an optical disk by an objective lens. The light reflected by the optical disk passes through the objective lens again, is converted from circularly polarized light to linearly polarized light in the directions perpendicular to the return path at the ¼ wave plate, and is incident upon the PBS again. The light incident upon the PBS again is reflected and incident upon a photo-detector, and is received by the photo-detector. The photo-detector converts the received light into an electric signal. The electric signal converted by the photo-detector is sent as an RF signal to a signal processing circuit.

FIG. 9 shows the electrical configuration of a signal processing circuit of a conventional optical pickup device. As shown in FIG. 9, an output signal (hereinafter, referred to as the former-light signal) outputted from a former-light detector 112 is sent to an LPC (or laser power control) circuit 114, and is used for power control of a laser 111. An output signal (hereinafter, referred to as the RF signal) outputted from a photo-detector 113 is sent to an RF detection circuit 116 which detects the RF signal and a servo-control circuit 117 which executes servo control of a motor that rotates an optical disk. Most of reflected light from an optical disk is designed to be received by the photo-detector 113. As a practical manner, however, the quantity of light which returns to the laser 111 varies according to the dispersion of birefringence quantities of an optical disk, the dispersion of optical properties or adjustments of a ¼ wave plate or a PBS, or the like.

FIG. 10 shows the relation between the laser's driving electric current and light-emission power. In the LPC circuit 114, control is executed using the former-light signal, so that emission power of the laser 111 becomes constant. In a state where the quantity of returning light is small (as shown by a solid line in FIG. 10), for example, when it emits light at a driving current of about 30 mA, if the quantity of returning light becomes great at a sufficiently higher speed than power control of the LPC circuit 114 (as shown by a dotted line in FIG. 10), then the laser 111's light-emission power increases.

FIG. 11 shows the relation between the RF signal and the former-light signal. On a recording track 130 on an optical disk, as shown in FIG. 11, a recording mark 131 and a space 132 are placed. In this case, if there is no variation in the laser's power as shown by a former-light signal wave-shape 134, this track is reproduced as shown by an RF-signal wave shape 133.

On the other hand, if a former-light wave shape 136 is varied, synchronously with the recording mark 131 and the space 132, by the influence of a variation (or a scoop) in emission power, then an RF-signal wave shape 135 undergoes changes in the reflectance factor or phase of the recording mark 131 and the space 132, and the laser power's modulation. This shifts the modulation factor in comparison with the RF-signal wave shape 133, thus aggravating a reproduction jitter or an error rate.

Among recording-type optical disks, for example, a CD-R or a DVD-R executes recording-power learning, using asymmetry; and a CD-RW or a DVD-RW, using modulation factors. This makes it impossible to execute recording-power learning precisely if there are laser-power variations synchronous with the RF signal. Besides, if asymmetry gets out of shape, then recording compensation learning cannot also be precisely executed which adjusts the edge shift of the front end or rear end of a recording mark.

Aiming at reducing the scoop of a laser which produces a bad effect on the detection of the RF signal as described above, there is proposed the art of heightening the reflectance factor on the emission-surface side of a laser and making small the quantity of returning light to the laser (e.g., refer to Patent Document 1). Or, the art is proposed of making great reproduction power and keeping down noises if a jitter is increased by a scoop while an optical disk is reproduced (e.g., refer to Patent Document 2).

Herein, Patent Document 1 is Japanese Patent Laid-Open No. 2001-189028 specification, and Patent Document 2 is Japanese Patent Laid-Open No. 2001-143299 specification.

The art according to Patent Document 1, which heightens the reflectance factor on the emission-surface side of a laser and makes small the quantity of returning light, has been expected to have an effect on an optical disk where the laser's emission-power variation is generated. However, it may have an adverse effect on an optical disk which has a higher reflectance factor than that on the laser's emission-surface side. Patent Document 2 describes the art of making great reproduction power if a jitter is increased by a scoop while an optical disk is reproduced. However, recording and reproduction of a recording-type optical disk are executed by raising the laser's emission power. Hence, making reproduction power far greater may lower the quality of the RF signal recorded on an optical disk. In short, there are some limitations on such an operation. In addition, raising reproduction power largely may lead to an increase in power consumption.

Thus, a variation in the laser's emission power generates a variation in modulation factors or asymmetry, thereby aggravating a reproduction jitter or an error rate. This also makes it difficult to precisely execute power learning or recording compensation learning for a recording-type optical disk such as a recording-type DVD or CD.

### BRIEF SUMMARY OF INVENTION

In order to resolve the aforementioned disadvantages, it is an object of the present invention to provide an optical pickup device, a signal processing method for the optical pickup device, and an optical disk drive unit which are capable of eliminating or lessening the influence on the RF signal that is produced by a variation in the emission power of a laser, without changing the structure of the laser or varying reproduction power.

The optical pickup device according to a first aspect of the present invention, which converges light emitted from a laser upon an optical disk through an objective lens and executes at least one of recording and reproduction of information on the optical disk, comprises: a first light detector which receives reflected light from the optical disk; a second light detector which receives a part of emitted light from the laser; a dividing means for dividing a first output signal outputted from the first light detector by a second output signal outputted from the second light detector; and an RF-signal detecting means for detecting an RF signal from the signal obtained by a division of the dividing means.

Furthermore, in this optical pickup device, preferably, the dividing means executes auto gain control of the first output signal outputted from the first light detector.

Furthermore, the above described optical pickup device, preferably, further comprises a first phase-compensation circuit which allows the phase of the first output signal outputted from the first light detector to agree with the phase of the second output signal outputted from the second light detector.

Furthermore, the above described optical pickup device, preferably, further comprises a second phase-compensation circuit which allows the phase of the second output signal outputted from the second light detector to agree with the phase of the first output signal outputted from the first light detector.

The optical pickup device according to a fifth aspect of the present invention, which converges light emitted from a laser upon an optical disk through an objective lens and executes at least one of recording and reproduction of information on the optical disk, comprises: a first light detector which receives reflected light from the optical disk; a second light detector which receives a part of emitted light from the laser; an amplitude correcting means for relating in advance the amplitude of a first output signal outputted from the first light detector and the amplitude of a second output signal outputted from the second light detector at least at two measurement points which differ in the amplitude of the first output signal, and correcting the amplitude of the first output signal, using a variation in the amplitude of the second output signal when the information is reproduced; and an RF-signal detecting means for detecting an RF signal from the first output signal whose amplitude is corrected by the amplitude correcting means.

Furthermore, in this optical pickup device, preferably, the amplitude correcting means relates the amplitude of the first output signal to the amplitude of the second output signal, by interpolating amplitude levels between the measurement points.

Furthermore, in the above described optical pickup device, preferably, the amplitude correcting means relates the amplitude of the first output signal to the amplitude of the second output signal, at two measurement points of the longest mark part and the longest space part.

Furthermore, in the above described optical pickup device, preferably, the amplitude correcting means relates the amplitude of the first output signal to the amplitude of the second output signal, at two or more measurement points which differ in the radius position of the optical disk.

Furthermore, in the above described optical pickup device, preferably, the amplitude correcting means relates the amplitude of the first output signal to the amplitude of the second output signal, by interpolating radius positions between the two or more measurement points where the amplitude of the first output signal is related to the amplitude of the second output signal.

Furthermore, in the above described optical pickup device, preferably, the amplitude correcting means relates the amplitude of the first output signal to the amplitude of the second output signal, at two measurement points of an interior-circumference part and an exterior-circumference part of the optical disk.

Furthermore, in the above described optical pickup device, preferably, the amplitude correcting means: measures the amplitude of the first output signal and the amplitude of the second output signal at two measurement points of a space part and a mark part of a specific reproduction signal; calculates the amplitude of the first output signal after corrected so that the emitted light of the laser becomes constant, based on the amplitude of the first output signal and the amplitude of the second output signal which are measured; creates an amplitude correction function, based on the first output signal before corrected and the first output signal after corrected; and corrects the amplitude of the first output signal when the information is reproduced, using the created amplitude correction function.

The signal processing method for an optical pickup device according to a twelfth aspect of the present invention, which converges light emitted from a laser upon an optical disk through an objective lens and executes at least one of recording and reproduction of information on the optical disk, comprises: a first light-receiving step of receiving reflected receiving from the optical disk with a first light detector; a second light-receiving step of receiving a part of emitted light from the laser with a second light detector; a dividing step of dividing a first output signal outputted from the first light detector by a second output signal outputted from the second light detector; and an RF-signal detecting step of detecting an RF signal from the signal obtained by a division of the dividing step.

The signal processing method for an optical pickup device according to a thirteenth aspect of the present invention, which converges light emitted from a laser upon an optical disk through an objective lens and executes at least one of recording and reproduction of information on the optical disk, comprises: a first light-receiving step of receiving reflected receiving from the optical disk with a first light detector; a second light-receiving step of receiving a part of emitted light from the laser with a second light detector; an amplitude correcting step of relating in advance the amplitude of a first output signal outputted from the first light detector and the amplitude of a second output signal outputted from the second light detector at least at two measurement points which differ in the amplitude of the first output signal, and correcting the amplitude of the first output signal, using a variation in the amplitude of the second output signal when the information is reproduced; and an RF-signal detecting step of detecting an RF signal from the first output signal whose amplitude is corrected in the amplitude correcting step.

The optical disk drive unit according to a fourteenth aspect of the present invention which is provided with a rotating means that rotates an optical disk, and an optical pickup device that executes at least one of recording and reproduction of information on the optical disk, wherein the optical pickup device comprises: a laser which emits light; a first light detector which receives reflected light obtained when emitted light from the laser is reflected by the optical disk; a second light detector which receives a part of emitted light from the laser; a dividing means for dividing a first output signal outputted from the first light detector by a second output signal outputted from the second light detector; and an RF-signal detecting means for detecting an RF signal from the signal obtained by a division of the dividing means.

The optical disk drive unit according to a fifteenth aspect of the present invention which is provided with a rotating means that rotates an optical disk, and an optical pickup device that executes at least one of recording and reproduction of information on the optical disk, wherein the optical pickup device comprises: a laser which emits light; a first light detector which receives reflected light obtained when emitted light from the laser is reflected by the optical disk; a second light detector which receives a part of emitted light from the laser; an amplitude correcting means for relating in advance the amplitude of a first output signal outputted from the first light detector and the amplitude of a second output signal outputted from the second light detector at least at two measurement points which differ in the amplitude of the first output signal, and correcting the amplitude of the first output signal, using a variation in the amplitude of the second output signal when the information is reproduced; and an RF-signal detecting means for detecting an RF signal from the first output signal whose amplitude is corrected by the amplitude correcting means.

The optical pickup device according to the present invention is capable of eliminating or lessening the influence on the RF signal that is produced by a variation in the emission power of a laser, without changing the structure of the laser or varying reproduction power, of detecting the RF signal precisely at the time of reproduction, and of executing control of recording power or recording compensation learning at the time of recording.

These and other objects, features and advantages of the present invention will become more apparent upon reading of the following detailed description along with the accompanied drawings.

### BRIEF DESCRIPTION OF THE DRAWINGS

FIG. 1 is a pictorial view, showing an example of the configuration of an optical pickup device according to the embodiments of the present invention.

FIG. 2 is a block diagram, showing the electrical configuration of a signal processing circuit in the optical pickup device according to the first embodiment.

FIG. 3 is a block diagram, showing the electrical configuration of a signal processing circuit in the optical pickup device according to the second embodiment.

FIG. 4 is a block diagram, showing the electrical configuration of a signal processing circuit in the optical pickup device according to a variation of the second embodiment.

FIG. 5 is a block diagram, showing the electrical configuration of a signal processing circuit in the optical pickup device according to the third embodiment.

FIG. 6 is an illustration, showing the relation between RF-signal amplitude and former-light signal amplitude.

FIG. 7 is a graphical representation, showing the amplitude of an RF signal and the amplitude of a former-light signal.

FIG. 8 is a graphical representation, showing the amplitude of an RF signal before corrected and the amplitude of an RF signal after corrected.

FIG. 9 is a block diagram, showing the electrical configuration of a signal processing circuit in a conventional optical pickup device.

FIG. 10 is a graphical representation, showing the relation between the driving electric current and light-emission power of a laser.

FIG. 11 is an illustration, showing the relation between an RF signal and a former-light signal.

### DETAILED DESCRIPTION OF INVENTION

Hereinafter, the optical pickup device according to each embodiment of the present invention will be described with reference to drawings.

(First Embodiment)

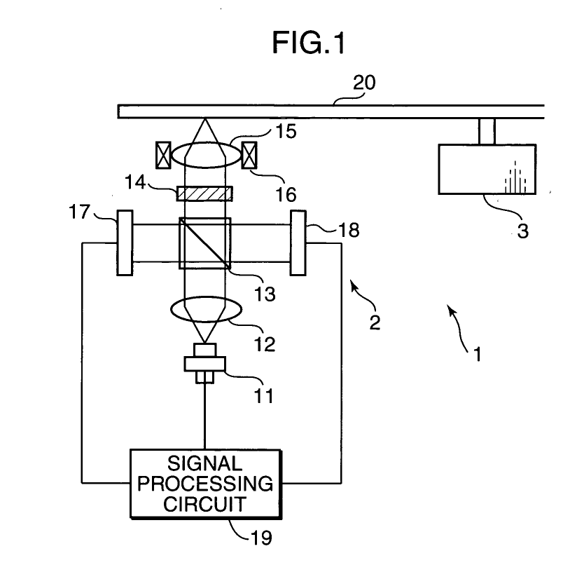

FIG. 1 is a pictorial view, showing an example of the configuration of an optical pickup device according to the embodiments of the present invention. As shown in FIG. 1, an optical disk drive unit 1 is configured by an optical pickup device 2 which converges light emitted from a laser upon an optical disk through an objective lens and executes at least one of recording and reproduction of information on the optical disk, and a spindle motor 3 which rotates an optical disk 20. The optical pickup device 2 is configured by: a laser 11 which emits light; a collimator lens 12 which makes parallel the light emitted by the laser 11; a PBS (or polarizing beam splitter) 13 which reflects a part of the light from the collimator lens 12 toward a former-light detector 17, transmits most of the light from the collimator lens 12 toward a ¼ wave plate 14, and reflects the light from the ¼ wave plate 14 toward a photo-detector 18; the ¼ wave plate 14 which converts linearly polarized light into circularly polarized light; an objective lens 15 which converges light upon the disk surface of the optical disk 20; an actuator 16 which drives the objective lens 15; the former-light detector (which corresponds to a second light detector) 17 which receives a part of the light emitted from the laser 11 and outputs an electric signal according to the received-light quantity; the photo-detector (which corresponds to a first light detector) 18 which receives the light reflected from the optical disk 20 and outputs an electric signal according to the received-light quantity; and a signal processing circuit 19 which executes signal processing of a control signal for controlling an output of the laser 11, an output signal outputted from the former-light detector 17, and an output signal outputted from the photo-detector 18. Herein, as the optical disk 20, there can be used an optical disk on which recording and reproduction can be executed (e.g., CD-R, CD-RW, DVD-RAM, DVD-R, DVD-RW, DVD+R, DVD+RW, BD, and the like), or an optical disk on which only reproduction can be executed (e.g., CD-ROM, DVD-ROM, and the like).

The light emitted from the laser 11 is incident upon the PBS 13 through the collimator lens 12. A part of the light incident upon the PBS 13 is reflected and is incident upon the former-light detector 17 which is the second light detector. Then, it is received by the former-light detector 17. The former-light detector 17 converts the light into an electric signal, and as the former-light signal (which corresponds to a second output signal), outputs the electric signal to the signal processing circuit 19. Most of the light incident upon the PBS 13 passes through the PBS 13 and is incident upon the ¼ wave plate 14. The light that has passed through the PBS 13 is converted, with respect to its polarization direction, from linearly polarized light to circularly polarized light by the ¼ wave plate 14. Then, it is converged upon the disk surface of the optical disk 20 by the objective lens 15. Herein, the objective lens 15 is driven in the perpendicular directions or the radius directions of the optical disk 20 by the actuator 16. The optical disk 20 is rotated by the spindle motor 3.

The light reflected by the optical disk 20 passes through the objective lens 15 again, and is converted from circularly polarized light to linearly polarized light in the directions perpendicular to the return path at the ¼ wave plate 14. The light that has again been incident upon the PBS 13 is reflected and incident upon the photo-detector 18. Then, it is received by the photo-detector 18. The photo-detector 18 converts the light into an electric signal, and as the RF signal (which corresponds to a first output signal), outputs the electric signal to the signal processing circuit 19.

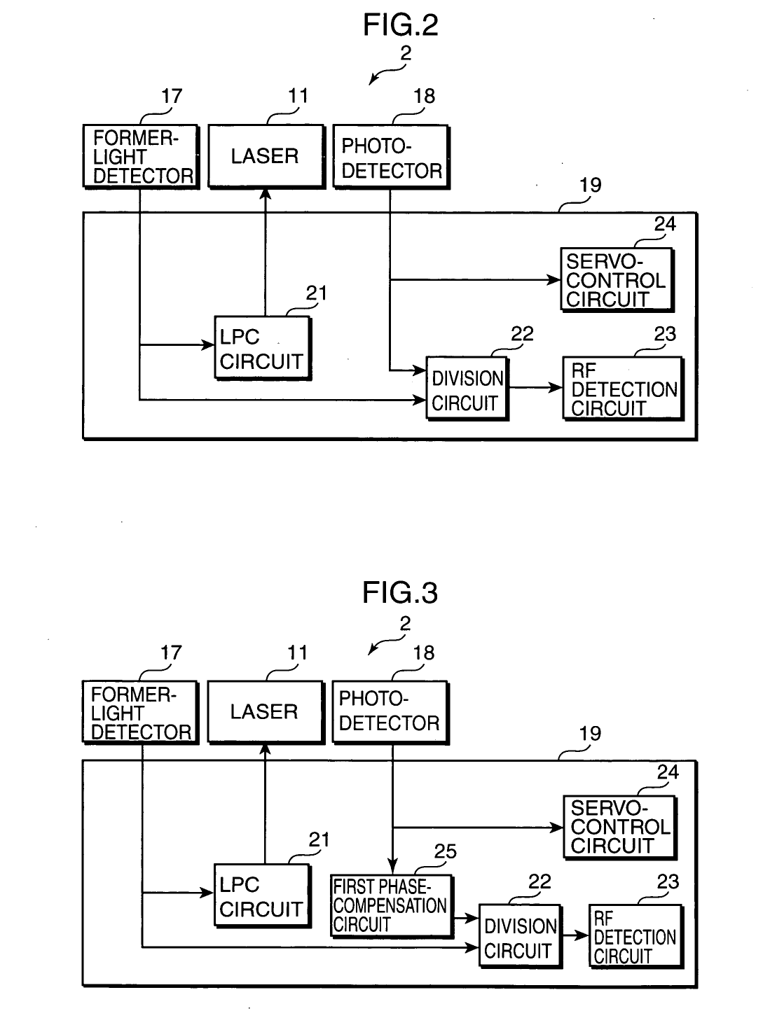

FIG. 2 is a block diagram, showing the electrical configuration of a signal processing circuit in the optical pickup device according to the first embodiment. As shown in FIG. 2, the optical pickup device 2 according to the first embodiment is configured by: the laser 11; the former-light detector 17, the photo-detector 18; and the signal processing circuit 19. The signal processing circuit 19 is configured by: an LPC (or laser power control) circuit 21; a division circuit 22; an RF detection circuit 23; and a servo-control circuit 24.

The LPC circuit 21 executes control, using the former-light signal outputted from the former-light detector 17, so that the laser 11's emission power becomes constant. The division circuit 22 divides the RF signal from the photo-detector 18 by the former-light signal from the former-light detector 17. The RF detection circuit 23 detects, as the RF signal, the signal obtained by a division of the division circuit 22. The servo-control circuit 24, based on the RF signal from the photo-detector 18, executes servo control of the actuator 16 or the spindle motor 3.

The former-light signal that is the second output signal which has been detected by the former-light detector 17 that is the second light detector is sent to the LPC circuit 21 and the division circuit 22. The division circuit 22 divides the RF signal that is the first output signal which has been inputted from the photo-detector 18 that is the first light detector, by the former-light signal inputted from the former-light detector 17. Then, it outputs the signal to the RF detection circuit 23.

Thus, if the laser 11's emission power varies, then the RF signal is corrected at the division circuit 22, using the former-light signal outputted from the former-light detector 17. This cancels a variation in the RF-signal amplitude which is made by a laser-power variation. In other words, the RF signal is detected by dividing the RF signal outputted from the photo-detector 18 by the former-light signal outputted from the former-light detector 17. Therefore, the influence on the RF signal which is produced by a variation in the emission power of the laser 11 can be eliminated or lessened without changing the structure of the laser 11 or varying reproduction power.

Furthermore, the variation in the RF-signal amplitude which is caused by a laser-power variation can be cancelled, even in a high band where it cannot be cancelled using laser-power control by the LPC circuit 21. In addition, for example, even if light-emission power varies at a recording mark or a space of an optical disk, then the influence on the modulation factor or asymmetry of the RF signal that is detected at the RF detection circuit 23, which is produced by a laser-power variation, can be eliminated or lessened.

Moreover, the RF signal can be precisely detected at the time of reproduction. Besides, even at the time of recording, power control can be precisely executed if recording power is determined using the asymmetry or modulation factor of the RF signal. The asymmetry of the RF-signal wave shape is precisely detected with determined recording power. Therefore, recording compensation learning can be precisely executed which adjusts the front end or rear end of a light-emission pulse at the time of recording so that the jitter of a recording mark becomes small.

Furthermore, a correction is executed by a division of the RF signal in real time. Accordingly, even though the reflectance factor or birefringence quantity of an optical disk differs as to its interior or exterior circumference or within one rotation and thus the returning light to the laser changes and the laser's power-variation quantity varies, then its influence can be cancelled.

According to this embodiment, the RF signal is corrected by dividing the RF signal by the former-light signal at the division circuit 22. However, it is not especially limited to this, specifically, the division circuit 22 may also be replaced with an auto gain control, or AGC, circuit. In this case, auto gain control is executed of the RF signal outputted from the photo-detector 18. This has the same effect as is obtained by dividing the RF signal outputted from the photo-detector 18 by the former-light signal outputted from the former-light detector 17. If the RF signal is detected from the signal obtained by executing auto gain control, the influence on the RF signal which is produced by a variation in the emission power of the laser can be eliminated or lessened without changing the structure of the laser or varying reproduction power. As a result, a gain adjustment can be made, thereby offering a greater effect.

(Second Embodiment)

Next, the optical pickup device according to a second embodiment of the present invention will be described. According to the first embodiment, the RF signal is corrected by dividing the RF signal by the former-light signal at the division circuit 22. However, there is a possibility that the variation in the RF-signal amplitude which is caused by a laser-power variation could not be precisely cancelled by the division circuit 22. This may occur in the case where the phase of the former-light signal inputted from the former-light detector 17 shifts from that of the RF signal inputted in the division circuit 22 from the photo-detector 18, because of the wiring of a signal cable, the configuration of a circuit, or the like. Therefore, according to the second embodiment, phase compensation is executed of the RF signal outputted from the photo-detector 18.

FIG. 3 is a block diagram, showing the electrical configuration of a signal processing circuit in the optical pickup device according to the second embodiment. As shown in FIG. 3, the optical pickup device 2 according to the second embodiment is configured by: the laser 11; the former-light detector 17, the photo-detector 18; and the signal processing circuit 19. The signal processing circuit 19 is configured by: the LPC circuit 21; the division circuit 22; the RF detection circuit 23; the servo-control circuit 24; and a first phase-compensation circuit 25. Hereinafter, only configurations will be described which are different from the optical pickup device according to the first embodiment.

The first phase-compensation circuit 25 measures in advance the length of a shift in phase between the RF signal outputted from the photo-detector 18 and the former-light signal outputted from the former-light detector 17. According to the length of a shift that has been measured beforehand, phase compensation of the RF signal outputted from the photo-detector 18 is executed so that the phase of the RF signal agrees with the phase of the former-light signal.

As described above, there is a case where the phase of the former-light signal inputted from the former-light detector 17 shifts from that of the RF signal inputted in the division circuit 22 from the photo-detector 18, because of the wiring of a signal cable, the configuration of a circuit, or the like. In such a case, the variation in the RF-signal amplitude by a laser-power variation cannot be precisely cancelled by the division circuit 22. Hence, the first phase-compensation circuit 25 is placed between the photo-detector 18 and the division circuit 22. Thus, the signal obtained by a phase compensation of the first phase-compensation circuit 25 is outputted as the RF signal to the division circuit 22.

In this way, the RF signal outputted from the photo-detector 18 passes through the first phase-compensation circuit 25. This allows the phase of the RF signal to agree with the phase of the former-light signal. Thereby, the variation in the RF-signal amplitude by a laser-power variation can be precisely cancelled by the division circuit 22. In short, precise operation is realized of the division circuit 22.

Next, the optical pickup device according to a variation of the second embodiment will be described. According to the above described second embodiment, phase compensation is executed of the RF signal outputted from the photo-detector 18. However, the present invention is not especially limited to this, specifically, phase compensation may also be executed of the former-light signal inputted from the former-light detector 17.

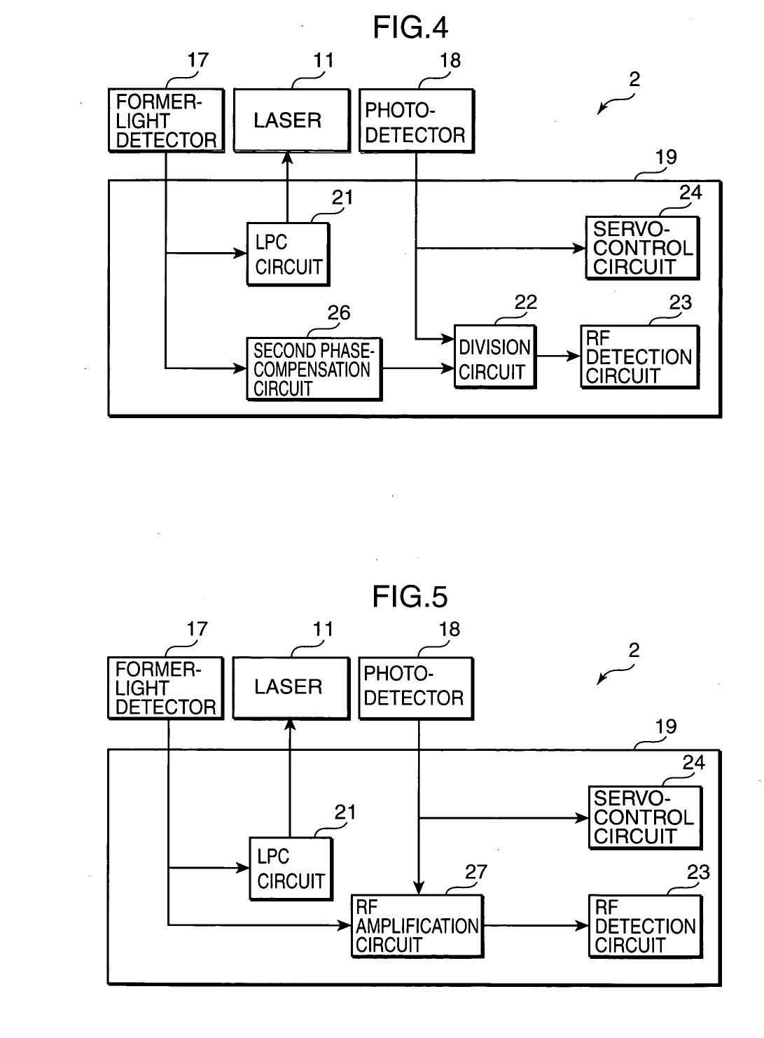

FIG. 4 is a block diagram, showing the electrical configuration of a signal processing circuit in the optical pickup device according to the variation of the second embodiment. As shown in FIG. 4, the optical pickup device 2 according to the variation of the second embodiment is configured by: the laser 11; the former-light detector 17, the photo-detector 18; and the signal processing circuit 19. The signal processing circuit 19 is configured by: the LPC circuit 21; the division circuit 22; the RF detection circuit 23; the servo-control circuit 24; and a second phase-compensation circuit 26. Hereinafter, only configurations will be described which are different from the optical pickup device according to the first embodiment.

The second phase-compensation circuit 26 measures in advance the length of a shift in phase between the RF signal outputted from the photo-detector 18 and the former-light signal outputted from the former-light detector 17. According to the length of a shift that has been measured beforehand, phase compensation of the former-light signal outputted from the former-light detector 17 is executed so that the phase of the RF signal agrees with the phase of the former-light signal.

As described above, in a case where the phase of the former-light signal shifts from that of the RF signal, there is a possibility that the variation in the RF-signal amplitude by a laser-power variation cannot be precisely cancelled by the division circuit 22. Hence, the second phase-compensation circuit 26 is placed between the former-light detector 17 and the division circuit 22. Thus, the signal obtained by a phase compensation of the second phase-compensation circuit 26 is outputted as the RF signal to the division circuit 22.

In this way, the former-light signal outputted from the former-light detector 17 passes through the second phase-compensation circuit 26. This allows the phase of the former-light signal to agree with the phase of the RF signal. Thereby, the variation in the RF-signal amplitude by a laser-power variation can be precisely cancelled by the division circuit 22. In short, precise operation is realized of the division circuit 22.

(Third Embodiment)

Next, the optical pickup device according to a third embodiment of the present invention will be described. According to the third embodiment, the amplitude of the RF signal from the photo-detector 18 is related to the amplitude of the former-light signal from the former-light detector 17, and then, that relation is stored in advance. When information is practically reproduced from an optical disk, the amplitude of the RF signal is corrected, using a variation in the amplitude of the former-light signal which has been related to a variation in the amplitude of the RF signal.

FIG. 5 is a block diagram, showing the electrical configuration of a signal processing circuit in the optical pickup device according to the third embodiment. As shown in FIG. 5, the optical pickup device 2 according to the third embodiment is configured by: the laser 11; the former-light detector 17, the photo-detector 18; and the signal processing circuit 19. The signal processing circuit 19 is configured by: the LPC circuit 21; the division circuit 22; the RF detection circuit 23; the servo-control circuit 24; and an RF amplification circuit 27. Hereinafter, only configurations will be described which are different from the optical pickup device according to the first embodiment.

The RF amplification circuit 27 corrects the RF signal from the photo-detector 18, based on the relation between the amplitude of the RF signal from the photo-detector 18 and the amplitude of the former-light signal from the former-light detector 17, which is stored beforehand.

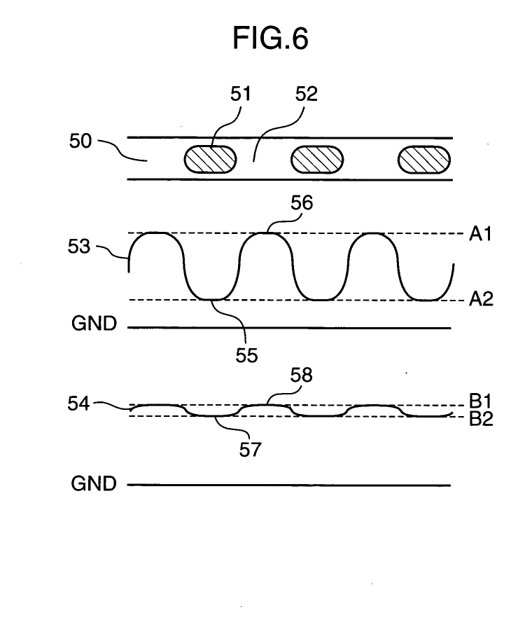

FIG. 6 is an illustration, showing the relation between RF-signal amplitude and former-light signal amplitude. As shown in FIG. 6, when a recording track 50 on an optical disk is reproduced, a former-light signal wave-shape 54 varies synchronously with a recording mark 51 or a space 52. Specifically, in the former-light signal wave-shape 54, the amplitude level of a space part 58 is B1 and the amplitude level of a mark part 57 is B2. Hence, amplitude levels vary between B1 and B2.

Accordingly, first, before information on an optical disk is practically reproduced, in the RF amplification circuit 27 are inputted: the former-light amplitude level B1 of the space part 58 of the former-light signal wave-shape 54 at the time when the RF amplitude level of a space part 56 of an RF-signal wave shape 53 which corresponds to the space 52 of the recording track 50 is A1; and the former-light amplitude level B2 of the mark part 57 of the former-light signal wave-shape 54 at the time when the RF amplitude level of a mark part 55 of the RF-signal wave shape 53 which corresponds to the recording mark 51 of the recording track 50 is A2. The RF amplification circuit 27 sets a gain in RF amplitude at the RF amplification circuit 27 so that the former-light amplitude levels become constant at the time of each RF amplitude level. Herein, preferably, at least two measurement points are the longest mark and the longest space on the recording track 50 of an optical disk.

The setting of a gain in RF amplitude between the related measurement points may also be executed by increasing the number of measurement points, or executing a linear interpolation. Besides, if measurement points are increased, measurement may also be executed at recording-mark parts or space parts which have different lengths. When the following reproduction is practically executed, the RF signal passes through the RF amplification circuit 27, and then, RF detection is executed at the RF detection circuit 23. This method has an advantage in that even though there are any variations in laser power, the RF signal's modulation by the laser-power variations can be cancelled. In addition, even if there is so much noise in the former-light signal, malfunctions are relatively avoidable because the average level of RF-amplitude amplification can be predetermined. Above all, there is no need for the division circuit 22 or AGC circuit which operate at high speed.

However, the RF amplification circuit 27 is preset and used. Therefore, if the radius position in which reproduction is executed on an optical disk is varied, the reflectance factor or birefringence changes, and the returning light varies, then the character of the RF amplification circuit 27 may shift from the character of an actual RF-signal wave shape. Hence, it is desirable that the character of the RF amplification circuit 27 be preset if the radius position of an optical disk is varied. Furthermore, measurement may also be executed at two points of an interior-circumference part and an exterior-circumference part of an optical disk. In that case, the character of the RF amplification circuit 27 is determined by executing a linear interpolation of a middle-circumference part between them. Herein, the interior-circumference part of an optical disk is the inside from the middle in the radius directions of a recording surface on the optical disk; and the exterior-circumference part is the outside from the middle. As described above, even if the birefringence of an optical disk varies, the variation in the RF-signal amplitude by a laser-power variation can be precisely corrected.

Thus, the amplitude of the RF signal outputted from the photo-detector 18 is related in advance to the amplitude of the former-light signal outputted from the former-light detector 17, at least at two measurement points which differ in the amplitude of the RF signal. Thus, the amplitude of the RF signal is corrected, using a variation in the amplitude of the former-light signal when information is reproduced. Therefore, the influence on the RF signal which is produced by a variation in the emission power of the laser 11 can be eliminated or lessened, without changing the structure of the laser 11 or varying reproduction power.

Furthermore, the amplitude of the RF signal is related to the amplitude of the former-light signal, by interpolating amplitude levels between the two or more measurement points where the amplitude of the RF signal has been related to the amplitude of the former-light signal. Therefore, based on the amplitude of the RF signal and the amplitude of the former-light signal which have been related by the interpolation, the amplitude of the RF signal can be corrected, using a variation in the amplitude of the former-light signal when information is reproduced. According to this embodiment, the amplitude of the RF signal is related to the amplitude of the former-light signal, by executing a linear interpolation of amplitude levels between measurement points. However, the present invention is not limited to this, especially. Specifically, the amplitude of the RF signal may also be related to the amplitude of the former-light signal by another interpolation method.

Furthermore, the amplitude of the RF signal can be related to the amplitude of the former-light signal, at two measurement points of the longest mark part and the longest space part of the optical disk 20. In addition, the amplitude of the RF signal can be related to the amplitude of the former-light signal, at two or more measurement points which differ in the radius position of an optical disk. Moreover, the amplitude of the RF signal can be related to the amplitude of the former-light signal, by interpolating radius positions between the two or more measurement points where the amplitude of the RF signal has been related to the amplitude of the former-light signal. Besides, the amplitude of the RF signal can be related to the amplitude of the former-light signal, at two measurement points of the interior-circumference part and the exterior-circumference part of an optical disk.

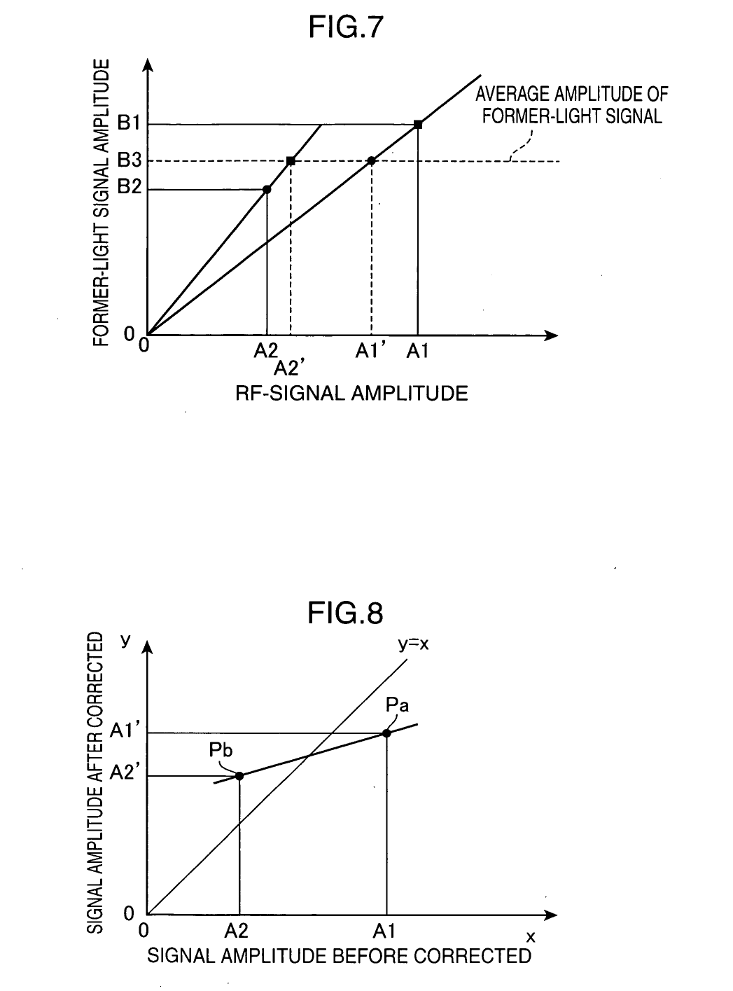

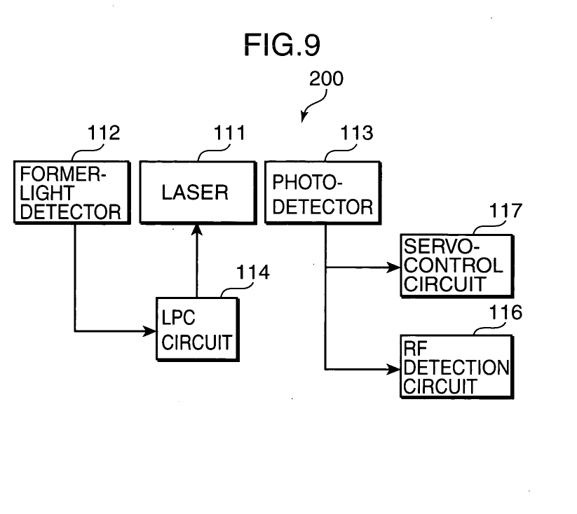

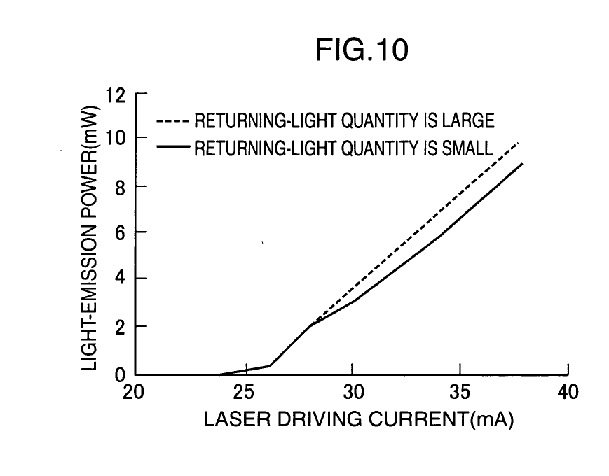

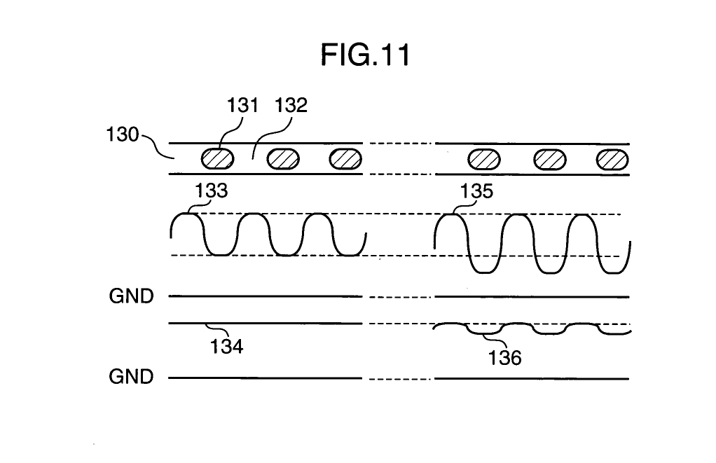

Herein, the optical pickup device according to the third embodiment will be described in further detail. FIG. 7 is a graphical representation, showing the amplitude of the RF signal and the amplitude of the former-light signal. Its vertical axis represents the amplitude level of the former-light signal, and the horizontal axis represents the amplitude level of the RF signal. FIG. 8 is a graphical representation, showing the amplitude of the RF signal before corrected and the amplitude of the RF signal after corrected.

First, the RF amplification circuit 27 measures the amplitudes of the RF signal and the former-light signal at two of a space part and a mark part of a specific reproduction signal, for example, such as an 11T single signal. Then, it calculates the amplitudes of the RF signal which is not affected by any scoop. As shown in FIG. 7, the average amplitude level of the former-light signal is designated as B3; the amplitude level at the space part of the former-light signal, B1; the amplitude level at the mark part of the former-light signal, B2; the amplitude level at the space part of the RF signal, A1; and the amplitude level at the mark part of the RF signal, A2. An RF-signal amplitude level A1′ at the space part and an RF-signal amplitude level A2′ at the mark part when there is no influence by any scoop (or the light emitted by a laser is constant) can be expressed using the following expressions (1) and (2).

A1′=(B3/B1)×A1 (1)

A2′=(B3/B2)×A2 (2)

Then, the RF amplification circuit 27 creates a first-order amplitude correction function, using the amplitude of the RF signal before corrected and the amplitude of the RF signal after corrected. As shown in FIG. 8, the first-order amplitude correction function which includes two points of a point Pa (A1, A1′) and a point Pb (A2, A2′) can be expressed using the following expression (3).

y={(A1′−A2′)/(A1−A2)}×(x−A1)+A1′ (3)

The RF amplification circuit 27 can obtain an amplitude y of the RF signal after corrected, by substituting the amplitude of the RF signal from the photo-detector 18 while information is reproduced for x of the first-order amplitude correction function expressed with the following expression (3).

In this way, the amplitude of the RF signal and the amplitude of the former-light signal are measured at the two measurement points of the space part and the mark part of the specific reproduction signal; based on the amplitude of the RF signal and the amplitude of the former-light signal which have been measured, the amplitude of the RF signal after corrected is calculated so that the emitted light of the laser becomes constant; and the amplitude correction function is created based on the RF signal before corrected and the RF signal after corrected. The amplitude correction function which has been created is stored in a storage section provided for the RF amplification circuit 27. Then, using the amplitude correction function stored in the storage section, the amplitude of the RF signal is corrected when information is reproduced. In brief, the amplitude correction function is created and stored beforehand, and then, the amplitude of the RF signal is corrected when information is reproduced using this amplitude correction function. This allows the amplitude of the RF signal to be easily corrected.

According to the above description, the correction is executed using the amplitude of the RF signal and the amplitude of the former-light signal at two points of a space part and a mark part of a specific reproduction signal, for example, such as an 11T single signal. However, the present invention is not limited to this, especially. For example, the number of measurement points may also be increased by sampling amplitudes between the maximum value (or space part) and the minimum value (or mark part) of an 11T single signal.

Furthermore, not only an 11T single signal, for example, but also an 11T single signal and a 3T single signal may also be used. In that case, the correction is executed using the amplitude of the RF signal and the amplitude of the former-light signal, at least at four points of a space part and a mark part of at least two such single signals.

In these cases, as the function which corrects the amplitude level of the RF signal and is equivalent to the above described expression (3), there is a method of executing a first-order approximation using a least-squares method, a method of calculating as the (n−1)ₜₕ-order function which includes n measurement points, or the like. If the number of measurement points is increased in this way, then a correction function becomes complex. However, an influence on the RF signal by a scoop can be precisely eliminated.

The optical pickup device, the signal processing method for the optical pickup device, and the optical disk drive unit according to the present invention are capable of eliminating or lessening the influence on the RF signal that is produced by a variation in the emission power of a laser, without changing the structure of the laser or varying reproduction power. They are useful as an optical pickup device, a signal processing method for the optical pickup device, an optical disk drive unit, and the like, which converges light emitted from the laser upon an optical disk through an objective lens and executes at least one of recording and reproduction of information on the optical disk.

This application is based on Japanese patent applications serial No. 2003-044528 filed in Japan Patent Office on Feb. 21, 2003, and serial No. 2004-003152 filed in Japan Patent Office on Jan. 8, 2004, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An optical pickup device which converges light emitted from a laser upon an optical disk through an objective lens and executes at least one of recording and reproduction of information on the optical disk, comprising:
a first light detector which receives reflected light from the optical disk;
a second light detector which receives a part of emitted light from the laser;
a dividing means for dividing a first output signal outputted from the first light detector by a second output signal outputted from the second light detector; and
an RF-signal detecting means for detecting an RF signal from the signal obtained by a division of the dividing means.

2. The optical pickup device according to claim 1, wherein the dividing means executes auto gain control of the first output signal outputted from the first light detector.

3. The optical pickup device according to claim 1, further comprising a first phase-compensation circuit which allows the phase of the first output signal outputted from the first light detector to agree with the phase of the second output signal outputted from the second light detector.

4. The optical pickup device according to claim 1, further comprising a second phase-compensation circuit which allows the phase of the second output signal outputted from the second light detector to agree with the phase of the first output signal outputted from the first light detector.

5. An optical pickup device which converges light emitted from a laser upon an optical disk through an objective lens and executes at least one of recording and reproduction of information on the optical disk, comprising:
a first light detector which receives reflected light from the optical disk;
a second light detector which receives a part of emitted light from the laser;
an amplitude correcting means for relating in advance the amplitude of a first output signal outputted from the first light detector and the amplitude of a second output signal outputted from the second light detector at least at two measurement points which differ in the amplitude of the first output signal, and correcting the amplitude of the first output signal, using a variation in the amplitude of the second output signal when the information is reproduced; and
an RF-signal detecting means for detecting an RF signal from the first output signal whose amplitude is corrected by the amplitude correcting means.

6. The optical pickup device according to claim 5, wherein the amplitude correcting means relates the amplitude of the first output signal to the amplitude of the second output signal, by interpolating amplitude levels between the measurement points.

7. The optical pickup device according to claim 5, wherein the amplitude correcting means relates the amplitude of the first output signal to the amplitude of the second output signal, at two measurement points of the longest mark part and the longest space part.

8. The optical pickup device according to claim 5, wherein the amplitude correcting means relates the amplitude of the first output signal to the amplitude of the second output signal, at two or more measurement points which differ in the radius position of the optical disk.

9. The optical pickup device according to claim 8, wherein the amplitude correcting means relates the amplitude of the first output signal to the amplitude of the second output signal, by interpolating radius positions between the two or more measurement points where the amplitude of the first output signal is related to the amplitude of the second output signal.

10. The optical pickup device according to claim 5, wherein the amplitude correcting means relates the amplitude of the first output signal to the amplitude of the second output signal, at two measurement points of an interior-circumference part and an exterior-circumference part of the optical disk.

11. The optical pickup device according to claim 5, wherein the amplitude correcting means: measures the amplitude of the first output signal and the amplitude of the second output signal at two measurement points of a space part and a mark part of a specific reproduction signal; calculates the amplitude of the first output signal after corrected so that the emitted light of the laser becomes constant, based on the amplitude of the first output signal and the amplitude of the second output signal which are measured; creates an amplitude correction function, based on the first output signal before corrected and the first output signal after corrected; and corrects the amplitude of the first output signal when the information is reproduced, using the created amplitude correction function.

12. A signal processing method for an optical pickup device which converges light emitted from a laser upon an optical disk through an objective lens and executes at least one of recording and reproduction of information on the optical disk, comprising:
a first light-receiving step of receiving reflected receiving from the optical disk with a first light detector;
a second light-receiving step of receiving a part of emitted light from the laser with a second light detector;
a dividing step of dividing a first output signal outputted from the first light detector by a second output signal outputted from the second light detector; and
an RF-signal detecting step of detecting an RF signal from the signal obtained by a division of the dividing step.

13. A signal processing method for an optical pickup device which converges light emitted from a laser upon an optical disk through an objective lens and executes at least one of recording and reproduction of information on the optical disk, comprising:
a first light-receiving step of receiving reflected receiving from the optical disk with a first light detector;
a second light-receiving step of receiving a part of emitted light from the laser with a second light detector;
an amplitude correcting step of relating in advance the amplitude of a first output signal outputted from the first light detector and the amplitude of a second output signal outputted from the second light detector at least at two measurement points which differ in the amplitude of the first output signal, and correcting the amplitude of the first output signal, using a variation in the amplitude of the second output signal when the information is reproduced; and
an RF-signal detecting step of detecting an RF signal from the first output signal whose amplitude is corrected in the amplitude correcting step.

14. An optical disk drive unit, which is provided with a rotating means that rotates an optical disk, and an optical pickup device that executes at least one of recording and reproduction of information on the optical disk, wherein the optical pickup device comprises:
a laser which emits light;
a first light detector which receives reflected light obtained when emitted light from the laser is reflected by the optical disk;
a second light detector which receives a part of emitted light from the laser;
a dividing means for dividing a first output signal outputted from the first light detector by a second output signal outputted from the second light detector; and
an RF-signal detecting means for detecting an RF signal from the signal obtained by a division of the dividing means.

15. An optical disk drive unit, which is provided with a rotating means that rotates an optical disk, and an optical pickup device that executes at least one of recording and reproduction of information on the optical disk, wherein the optical pickup device comprises:
a laser which emits light;
a first light detector which receives reflected light obtained when emitted light from the laser is reflected by the optical disk;
a second light detector which receives a part of emitted light from the laser;
an amplitude correcting means for relating in advance the amplitude of a first output signal outputted from the first light detector and the amplitude of a second output signal outputted from the second light detector at least at two measurement points which differ in the amplitude of the first output signal, and correcting the amplitude of the first output signal, using a variation in the amplitude of the second output signal when the information is reproduced; and
an RF-signal detecting means for detecting an RF signal from the first output signal whose amplitude is corrected by the amplitude correcting means.
